(19) United States
(12) Patent Application Publication
(10) Pub. No.: US 2026/0091503 A1
(43) Pub. Date: Apr. 2, 2026

(54) METHODS FOR TOKENIZATION REPRESENTATION AND LEARNING OF ROBOTIC PERCEPTION DATA BASED ON GRAPH NEURAL NETWORK

(71) Applicant: TONGJI UNIVERSITY, Shanghai (CN)

(72) Inventors: Bin HE, Shanghai (CN); Shuo JIANG, Shanghai (CN); Jiahang LIU, Shanghai (CN); Zihan LI, Foshan (CN); Zhipeng WANG, Shanghai (CN); Yanmin ZHOU, Shanghai (CN)

(73) Assignee: TONGJI UNIVERSITY, Shanghai (CN)

(21) Appl. No.: 19/342,432

(22) Filed: Sep. 26, 2025

(30) Foreign Application Priority Data
Sep. 27, 2024 (CN) 202411363004.6

(51) Int. Cl. B25J 9/16

(52) U.S. Cl. CPC B25J 9/1697; B25J 9/161

(57) ABSTRACT

Provided is a method for token-based representation and learning of robotic perception data based on a graph neural network, comprising: obtaining a plurality of types of perception data of a robot; performing token-based representation according to types of the plurality of types of perception data; constructing an initial feature graph based on the plurality of types of perception data after the token-based representation; learning a compact representation of the initial feature graph based on an autoencoder and reconstructing a graph structure; after the autoencoder completes learning of the graph structure, fixing the graph structure; and converting the plurality of types of perception data into node feature vectors, constructing a feature graph based on the graph structure, and performing numerical encoding on each of the node feature vectors by utilizing the graph neural network to obtain a representation of high-dimensional feature vectors of the plurality of types of perception data.

### CROSS-REFERENCE TO RELATED APPLICATIONS

This application claims priority to the Chinese Patent Application No. 202411363004.6, filed on Sep. 27, 2024, the contents of which are hereby incorporated by reference.

### TECHNICAL FIELD

The present disclosure relates to a field of robotic perception data processing technology, and in particular, to a method for token-based representation and learning of robotic perception data based on a graph neural network.

### BACKGROUND

Currently, in the field of natural language processing, tokenization serves as a critical step in text preprocessing and exerts a crucial influence on subsequent tasks (such as sentiment analysis, machine translation, and question-answering systems). Traditional tokenization manners mainly rely on dictionary matching and statistical models, but often perform poorly when dealing with new words, polysemous words, and long complex sentences. With the development of deep learning, neural network-based manners have gradually become mainstream, especially Recurrent Neural Network (RNN) and Long Short-Term Memory (LSTM), etc., which have achieved significant results in tokenization tasks. Subsequently, embedding techniques, by converting discrete words into vector representations in a high-dimensional space, not only enable computers to process textual information but, more importantly, allow vectors to mathematically capture semantic and syntactic relationships between words, enabling machines to understand text content to some extent.

Consequently, for applications such as text classification, sentiment analysis, and machine translation, both tokenization and embedding provide the system with the capability to understand and process natural language. Together, they form the cornerstone of the modern natural language processing technology stack, greatly enhancing the accuracy and efficiency of various language processing tasks.

Modern robotics technology has been widely applied across a plurality of fields, including the industrial manufacturing and the service industry. To enable robots to better understand and execute tasks, it is usually necessary to convert perception data into a computer-processable form. However, most existing manners for processing the perception data rely on fixed data structures and simple feature extraction techniques, which limit the ability of the robot to understand complex environments and the flexibility of task execution.

With the development of artificial intelligence technology, especially the application of large pre-trained models, robotic systems have made significant progress in decision control. These large pre-trained models are capable of handling complex tasks and learning patterns from large amounts of data to make more intelligent decisions. However, in order to make these large pre-trained models useful in real-world robotics applications, they need to be tightly coupled with embodied perceptual inputs of the robot.

Robot perceptual inputs include, but are not limited to multi-dimensional data such as degree-of-freedom data, end-effector pose data, visual perception data, and tactile perception data. To enable the large pre-trained model to effectively utilize this information, it is necessary to transform the perception data into a form that can be understood by the large pre-trained model. Ideally, the perception data should be transformed into high-dimensional vectors, and a conversion process preserves interrelationships between different dimensions of the perception data as well as the information carried by each dimension.

Currently, although the field of natural language processing has developed relatively mature tokenization and embedding manners that effectively convert text into semantically rich vector representations, similar manners for robotic perception data are relatively scarce. When processing the robotic perception data, simpler approaches such as directly using raw numerical values or basic feature engineering are typically employed. Such methods cannot adequately express the complexity and multi-dimensional nature of the perception data.

Furthermore, due to a lack of effective tokenization and embedding manners, existing robotic systems struggle to fully leverage the capabilities of large pre-trained models for processing perception inputs. This results in robots that are limited in their decision-control performance when faced with dynamic and complex environments, and are not able to cope with situations as flexibly as humans.

Therefore, there is an urgent need for a method for token-based representation and learning of robotic perception data based on a graph neural network. The method should effectively convert the robotic perception data into the high-dimensional vectors while preserving the interrelationships within the perception data, thereby better serving the decision-making and control systems of robots.

### SUMMARY

A purpose of the present disclosure is to provide a method for token-based representation and learning of robotic perception data based on a graph neural network (GNN), aiming at transforming multi-dimensional perception inputs of a robot into high-dimensional vectors and preserving the relational information between different dimensional perception data.

The purpose of the present disclosure is realized by the following technical solutions:

One or more embodiments of the present disclosure provide a method for token-based representation and learning of robotic perception data based on a graph neural network, comprising: obtaining a plurality of types of perception data of a robot; performing token-based representation according to types of the plurality of types of perception data; constructing an initial feature graph based on the plurality of types of perception data after the token-based representation; learning a compact representation of the initial feature graph based on an autoencoder and reconstructing a graph structure, wherein the graph structure represents a relationship of edges between different nodes, the autoencoder includes an encoder and a decoder, the encoder employs a graph attention network, the encoder is configured to map node features to a latent space, and the decoder reconstructs the graph structure from the latent space; after the autoencoder completes learning of the graph structure, fixing the graph structure; and converting the plurality of types of perception data into node feature vectors, constructing a feature graph based on the graph structure, and performing numerical encoding on each of the node feature vectors by utilizing the graph neural network to obtain a representation of high-dimensional feature vectors of the plurality of types of perception data.

### BRIEF DESCRIPTION OF THE DRAWINGS

FIG. 1 is an exemplary flowchart of a method for token-based representation and learning of robotic perception data based on a graph neural network according to some embodiments of the present disclosure;

FIG. 2 is a schematic diagram of a graph attention network model architecture according to some embodiments of the present disclosure;

FIG. 3 is an exemplary flowchart of a process for reconstructing a graph structure according to some embodiments of the present disclosure;

FIG. 4 is an exemplary flowchart of a process for performing numerical encoding on node feature vectors according to some embodiments of the present disclosure;

FIG. 5 is an exemplary flowchart of a process for performing image acquisition and data acquisition according to some embodiments of the present disclosure; and

FIG. 6 is a schematic diagram of generating a robotic arm control instruction according to some embodiments of the present disclosure.

### DETAILED DESCRIPTION

The present disclosure is described in detail below in connection with the accompanying drawings and specific embodiments. The present embodiments are implemented on the premise of the technical program of the present disclosure, and detailed implementation and specific operation processes are given, but the scope of protection of the present disclosure is not limited to the following embodiments.

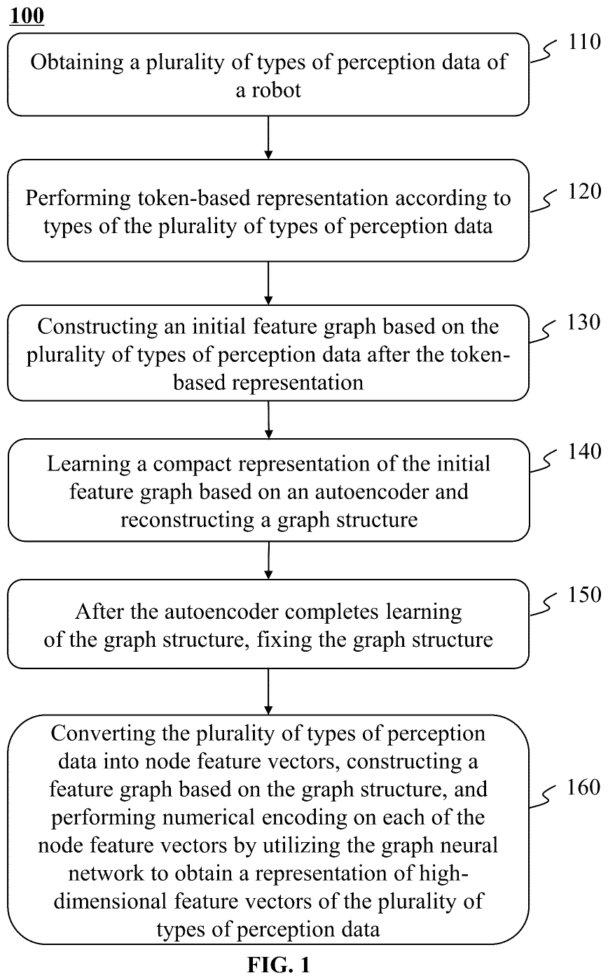

FIG. 1 is an exemplary flowchart of a method for token-based representation and learning of robotic perception data based on a graph neural network according to some embodiments of the present disclosure.

The present embodiment provides the method for token-based representation and learning of robotic perception data based on the graph neural network, as shown in FIG. 1, and the process 100 is executed by a processor. Process 100 includes the following step 110-step 160.

In some embodiments, the processor may include a central processing unit, a microprocessor, an application-specific integrated circuit, or the like for executing a relevant program for realizing a technical solution provided by embodiments of the present disclosure.

Step 110, obtaining a plurality of types of perception data of a robot.

Perception data refers to raw digital signals used to characterize a state of a physical world and environment.

In some embodiments, the plurality of types of perception data includes at least one of degree-of-freedom state data, end-effector pose data, visual perception data, tactile perception data, and pressure sensor data.

The degree-of-freedom state data refers to motion state information of each joint of the robot. The degree-of-freedom state data includes a position of the joint, a velocity of the joint, an acceleration of the joint, etc.

The end-effector pose data refers to a position and orientation information of a robot end-effector (e.g., a robotic gripper) in space. For example, the end-effector pose data includes three-dimensional coordinates of the robot end-effector and Euler angles of the robot end-effector.

The visual perception data refers to environmental information acquired through visual sensors (e.g., cameras and Light Detection and Ranging (LiDAR)). For example, the visual perception data includes visual image data (e.g., RGB images and depth images), and point cloud data (e.g., LIDAR point cloud data).

The tactile perception data refers to tactile information acquired through tactile sensors (e.g., force-sensitive resistors, capacitive sensors). For example, the tactile perception data includes a contact force, a contact position, or a contact state.

The pressure sensor data refers to physical quantity information acquired through a pressure sensor. For example, the pressure sensor data includes a pressure.

In some embodiments, the processor may obtain the plurality of types of perception data of the robot through sensors (e.g., an inertial measurement unit, a torque sensor, a visual sensor, the tactile sensor, and the pressure sensor) to build a multimodal perception dataset for the robot.

Step 120, performing token-based representation according to types of the plurality of types of perception data.

The types refer to different data types formed by classifying the plurality of types of perception data based on dimensions such as a source, a modality, and a structural characteristic. For example, the types of the plurality of types of perception data include a discrete data type, a continuous numerical input, and temporal data.

In some embodiments, the processor categorizes the perception data as one or more of the discrete data type, the continuous numerical input, and the temporal data, based on data characteristics of the perception data (e.g., the degree-of-freedom state data, the end-effector pose data, the visual perception data, the tactile perception data, and the pressure sensor data). For example, the end-effector pose data typically consists of a set of continuously varying coordinate values that are continuously recorded over time, and thus, the end-effector pose data belongs to both the continuous numerical input and the temporal data.

The token-based representation refers to a result of processing the perception data through tokenization and converting the perception data into mathematical vectors that can be processed by a computer.

For the plurality of types of perception data that are input, the token-based representation is required to convert the plurality of types of perception data into a form that models can process. Unlike tokenization in natural language processing, due to an existence of different types of the perception data of the robot, paradigms for the token-based representation need to be established separately. The tokenization refers to decomposing a text into minimal semantic units to facilitate model processing.

In some embodiments, for the perception data of the discrete data type, perception data of different kinds are treated as different tokens and the token-based representation is performed. The different tokens correspond to different nodes in the graph neural network.

The discrete data type refers to the perception data represented as a discrete value. For example, robot joint state data (e.g., a joint angle) may be represented as a discrete state value, an angle of joint 1=30°, an angle of joint 2=45°, etc.

In some embodiments, the processor filters the perception data after filtering out the perception data belonging to the discrete data type based on the data characteristics. Each piece of perception data is then distinguished according to its physical origin and meaning (e.g., a visual, a tactile, and different joints), considered as perception data of different kinds under the discrete data type, and classified into different tokens. For example, both of “an angle of joint 1=30°” and “an angle of joint 2=45°” belong to the discrete data type, but due to differences in joint and angle, the processor may treat “an angle of joint 1=30°” as token A and “an angle of joint 2=30°” as token B.

For the perception data of the discrete data type, the processor considers each discrete data with different attributes as different tokens, and each token is mapped as a node of the GNN and optimized as a high-dimensional vector through a message passing mechanism of the GNN to retain physical correlation information.

The different tokens are identifiers for the discrete data with different origins or physical meanings. For example, in the robot joint state data, “an angle of joint 1=30°” and “an angle of joint 2=45°” are two different tokens.

The node refers to a basic unit in the GNN to represent the perception data after the token-based representation. For example, a token “an angle of joint 1=30°” corresponds to node 1, and a token “an angle of joint 2=45°” corresponds to node 2. Each node may carry an initial feature vector and interact with other nodes through the message passing mechanism of the GNN.

By treating the perception data of the discrete data type from different sources as the different tokens and corresponding to different nodes in the GNN, a correlation between the discrete data can be effectively modeled, and the original semantic information of the perception data can be retained to enhance an ability to understanding complex environments of the robot.

In some embodiments, for the perception data of the continuous numerical input, using the graph attention network as an embedding network and performing the token-based representation. The graph attention network learns a high-dimensional representation of numerical values and captures relationships and structures between the numerical values.

The continuous numerical input refers to the perception data represented as continuous numerical values. For example, the continuous numerical input includes the end-effector pose data of the robot or the pressure sensor data.

The processor maps the perception data of the continuous numerical input into initial vectors through a multi-layer perceptron. The graph attention network computes attention coefficients between the nodes and performs weighted aggregation of neighbor node features based on the attention coefficients to generate a new high-dimensional representation.

The embedding network refers to a neural network module that maps original data into the high-dimensional vectors. For example, the graph attention network acts as the embedding network that may transform the continuous numerical input (e.g., an end position) into the high-dimensional vectors while capturing nonlinear relationships between the numerical values (e.g., a differential relationship between a position and a velocity).

For the perception data of the continuous numerical input, the processor uses the graph attention network as the embedding network to transform the continuous numerical values into vectors and input the vectors, as the token-based representation, into the GNN.

Using the graph attention network to learn the high-dimensional representations of the continuous numerical values, complex relationships between the numerical values can be effectively captured, limitations of traditional feature engineering can be avoided, the expressive power for continuous data can be enhanced, and more accurate input can be provided for real-time robot decision-making.

In some embodiments, for the perception data of the temporal data, dividing the perception data of the temporal data into a plurality of time segments according to a preset time length, and performing feature extraction or an encoding process on each of the plurality of time segments to obtain the token-based representation; or, transforming the perception data of the temporal data to obtain time-domain features or frequency-domain features, and using the time-domain features or the frequency-domain features as the token-based representation.

The temporal data refers to the perception data arranged in chronological order, usually in a form of a time series. For example, the temporal data includes sensor data such as the acceleration, a temperature, and a distance.

The preset time length refers to a time period for splitting the temporal data into fixed lengths of time, which is set by a specialized technician.

The feature extraction refers to a process of extracting relevant features from each time period. For example, extracting features such as a mean, a variance, and a peak value from a certain time period. The encoding process refers to a process of transforming the extracted features into vectors to perform the token-based representation.

The time-domain features refer to a feature extracted from the preset time length, reflecting the time-domain properties of the data. For example, the time-domain features include a peak value of the acceleration data and a rate of crossing zero of the acceleration data.

In some embodiments, the processor may extract the time-domain features via a sliding window technique.

The frequency-domain features are features extracted by performing time-frequency analysis manners on the perception data of the temporal data, reflecting the frequency characteristics of the data. For example, the frequency-domain features include a spectral dominant frequency of the acceleration data and a band energy of the acceleration data.

In some embodiments, the processor may obtain the frequency-domain features by performing the Fourier transform on the perception data of the temporal data.

In some embodiments, the processor extracts the time-domain features or the frequency-domain features for the temporal data and combines the time-domain features or the frequency-domain features into vectors of a predetermined length as the token-based representation. The predetermined length may be predetermined.

Through a temporal segmentation and a feature extraction, the dynamic characteristics of the temporal data can be effectively processed while retaining key information in the time and frequency domains, providing a flexible token-based representation of the perception data of the robot for a plurality of sensor data.

Step 130, constructing an initial feature graph based on the plurality of types of perception data after the token-based representation.

The initial feature graph refers to a form of data in which the perception data after the token-based representation is represented as a graph structure.

The initial feature graph includes a plurality of nodes and edges. The nodes of the initial feature graph represent the token-based representations of the perception data, and the edges of the initial feature graph represent physical correlations or semantic relationships between the perception data or the like. An edge is established between two nodes if the tokens of the perception data have mutual influence or dependency at the physical, logical, or temporal level. For example, in text data, the edges of the initial feature graph may represent co-occurrence relationships or grammatical dependency relationships between tokens. For example, in the visual image data, the edges of the initial feature graph may represent spatial adjacencies between regions.

The spatial adjacencies refer to representations of the physical associations between the nodes of the initial feature graph. For example, an edge exists between two joint nodes connected by the same robotic arm linkage because their motion states interact with each other and are physically coupled.

For example, the initial feature graph may be characterized by G=(V, E), where V denotes a set of the nodes of the initial feature graph, E denotes a set of the edges of the initial feature graph, and a feature vector exists for each node.

Both the nodes of the initial feature graph and the edges of the initial feature graph have features. Node features of the initial feature graph are vectors of attributes of the nodes of the initial feature graph (e.g., the node features of a joint angle may include angle values, angular velocities, and torques). Edge features of the initial feature graph include quantitative descriptions of physical relationships (e.g., linkage coefficients between joints, Euclidean distances for spatial distances, and time differences for temporal dependency).

In some embodiments, the processor constructs the initial feature graph based on the nodes of the initial feature graph, the edges of the initial feature graph, the node features of the initial feature graph, and the edge features of the initial feature graph.

Step 140, learning a compact representation of the initial feature graph based on an autoencoder and reconstructing the graph structure.

The compact representation refers to a compressed representation obtained by mapping the node features of the initial feature graph to a latent space via an encoder of an autoencoder.

The compact representation retains core information of the perception data (e.g., category semantics of the discrete data, physical magnitude of the continuous numerical values, and dynamic properties of the temporal data), while removing redundant information through dimensionality reduction to enhance the computational efficiency and generalization ability of subsequent tasks.

The graph structure is the structure of the initial feature graph after optimization by learning from the autoencoder.

In some embodiments, the graph structure represents relationships of edges between different nodes.

Nodes of the graph structure are the same as the nodes of the initial feature graph.

Edges of the graph structure are results of optimizing the edges of the initial feature graph, which is usually obtained by learning through the autoencoder or the graph neural network, in order to better reflect the semantic or functional relationships between the nodes of the graph structure. For example, in the text data, initial co-occurrence-based edges may be optimized to semantic similarity-based edges.

Node features of the graph structure are encoded or optimized versions of the node features of the initial feature graph. For example, the node features of the graph structure include embedding vectors.

Edge features of the graph structure are results of optimization of the edge features of the initial feature graph. For example, the edge features of the graph structure include the attention coefficients and weighting matrices of the edge features of the initial feature graph.

The graph structure is constructed for a purpose of encoding the plurality of types of perception data of the robot and retaining information about itself and information about relationships between different perception data. The collected perception data are all derived from the robot's physical system, and therefore, conform to laws of the physical world. The autoencoder is used to learn the compact representation of the graph structure. In some embodiments, the autoencoder includes an encoder and a decoder. The encoder employs a graph attention network. The encoder maps the node features to the latent space. The decoder reconstructs the graph structure from the latent space. For example, the decoder uses the embedding vectors in the latent space to try to reconstruct the initial graph structure (i.e., connectivity of the edges of the graph structure). By training to minimize a difference between the reconstructed graph structure and the initial feature graph, the autoencoder learns the embedding vectors that contain both the own features of the nodes and the graph structure information.

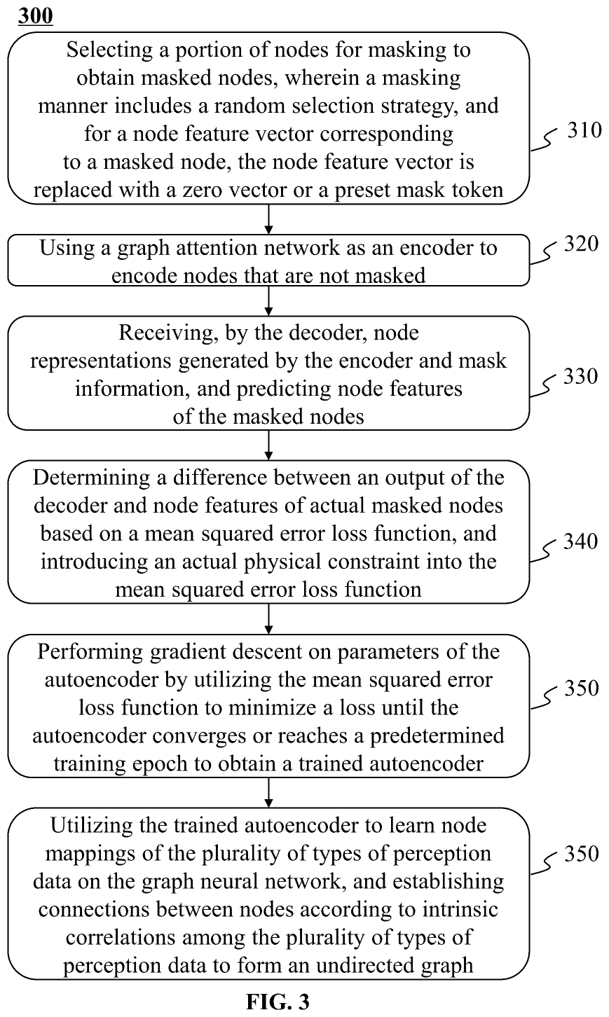

More descriptions regarding how to reconstruct the graph structure may be found elsewhere in the present disclosure (e.g., FIG. 3 and related descriptions thereof).

Step 150, after the autoencoder completes learning of the graph structure, fixing the graph structure.

Fixing the graph structure refers to an operation of keeping topological relationships between the nodes and the edges and the corresponding parameters obtained by the autoencoder learning unchanged. For example, after the autoencoder completes an encoding and a reconstruction process of the initial feature graph, the parameters of the graph structure learned by the encoder and the decoder (e.g., connection weights between the nodes, strengths of the edges, or the attention coefficients) are frozen, and only the topological form of the graph structure is preserved. The fixed graph structure serves as prior knowledge to guide the graph neural network to perform numerical encoding on the node feature vectors in step 160, thereby ensuring that the physical correlations and semantic relationships between the perception data are stably preserved in subsequent processing, enhancing a generalization ability of the model and representational consistency.

Step 160, converting the plurality of types of perception data into node feature vectors, constructing a feature graph based on the graph structure, and performing numerical encoding on each of the node feature vectors by utilizing the graph neural network to obtain a representation of high-dimensional feature vectors of the plurality of types of perception data.

The node feature vectors are feature representations of the plurality of types of perception data transformed into numerical values form and used as inputs to the graph neural network after the token-based representation.

The node feature vectors are usually generated from the perception data after preprocessing, disambiguation, embedding, etc., and their dimensionality and content depend on the type of the perception data and encoding manner. For example, LIDAR point cloud data may be represented as the numerical values vectors containing information such as position and intensity. The visual image data may be represented as visual feature vectors extracted through the convolutional neural network.

The feature graph is similar to the graph structure, with the distinction that the graph structure focuses more on the topological relationships of the nodes and the edges, representing an abstract relational model that has been learned or optimized. The feature graph, on the other hand, is a concrete instantiated representation that further incorporates the node feature vectors based on this structure, serving as the data carrier that can be directly input into the graph neural network.

The construction of the feature graph is similar to the construction of the graph structure, and will not be repeated here.

The high-dimensional feature vectors refer to output vectors with richer information and higher dimensionality, obtained after the graph neural network performs information fusion and encoding on the node feature vectors. For example, the high-dimensional feature vectors include end-effector pose information, joint angle information, visual data information, and motor torque information.

The end-effector pose information is used to characterize a location in space where the pressure data is generated. The joint angle information is used to characterize an attitude that causes the contact to be generated. The visual data information is used to characterize an object that generated the pressure. The motor torque information is used to characterize a pressure that needs to be applied by the robot itself.

Merely by way of example, the characterization of the high-dimensional feature vectors can be understood as a complete and compact mathematical description of a complex scenario such as “the robot is currently applying 5.2 units of pressure with its fingertip, which is in position (x, y, z) due to the current joint configuration, while a red square is visually observed, and the entire state is dynamically coherent”. It fuses multimodal perceptual information (tactile, proprioceptive, visual) into a unified vector space, providing high-quality, high-information-density input for subsequent decision-making, control, or learning tasks.

In some embodiments, firstly, the processor may input the constructed feature graph into the GNN. The GNN aggregates feature information from the neighbor nodes through the message passing mechanism; then, the node feature vectors are nonlinearly transformed using operations such as graph convolution, graph attention, or graph isomorphism network; finally, transformed node feature vectors are mapped to a high-dimensional space through a fully connected layer, and the corresponding high-dimensional feature vectors of each node are output.

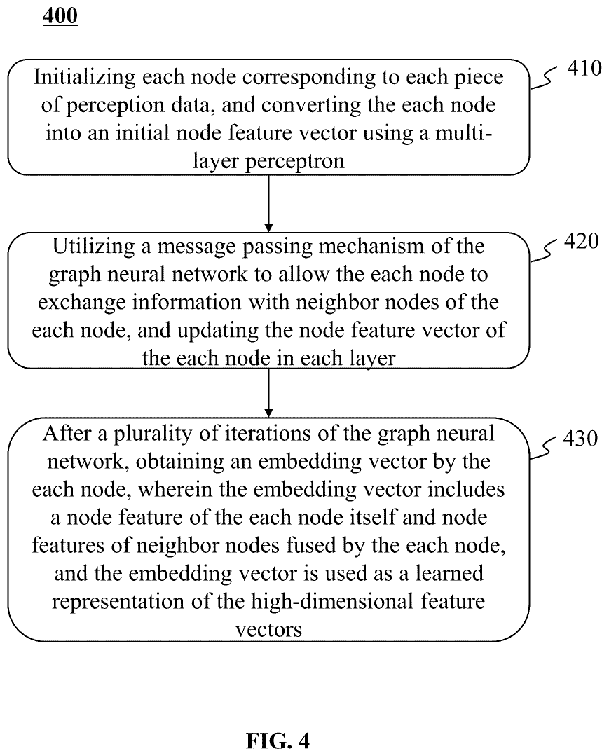

More descriptions regarding the high-dimensional feature vectors may be found elsewhere in the present disclosure (e.g., FIG. 4 and related descriptions thereof).

By performing the token-based representation according to the types of the plurality of types of perception data and constructing the initial feature graph, and combining the autoencoder to learn the compact representation of the initial feature graph and reconstruct the graph structure, the effective preservation of physical and semantic associations between the perception data is achieved. After fixing the graph structure, the GNN is used to numerically encode the node feature vectors, finally obtaining the high-dimensional feature vectors representation. This helps improve the fusion capability and representational accuracy of multi-modal perception data, enhancing the usability and robustness of perceptual information in complex robot systems.

In some embodiments of the present disclosure, by introducing the techniques and concepts of tokenization and embedding from the large model domain in natural language into the perception data of the robot processing, a technical gap in the relevant field is filled. The GNN is adopted as the core technical means for processing the perception data of the robot. The GNN can effectively model the relationships between different perception data and convert them into high-dimensional vector representations, thereby preserving the interrelationships between the perception data. Compared to traditional manners that use only the raw numerical values or simple feature engineering, this approach can better express the complexity and multi-dimensional nature of the perception data. Furthermore, based on the physical system, it autonomously learns the token-based representation of the multi-dimensional perception of the robot while preserving the relationships between different dimensions of the perception data. This facilitates large models in better understanding the robot's decision-making and control in complex environments when processing robot input information.

FIG. 3 is an exemplary flowchart of a process for reconstructing a graph structure according to some embodiments of the present disclosure.

In some embodiments, process 300 is executed by the processor as shown in FIG. 3. The process 300 includes the following step 310-step 360:

Step 310, selecting a portion of nodes for masking to obtain masked nodes. A masking manner includes a random selection strategy. For a node feature vector corresponding to a masked node, the node feature vector is replaced with a zero vector or a preset mask token.

The random selection strategy refers to selecting nodes that need to be masked by uniform distribution random sampling according to a preset mask ratio in the nodes of an initial feature graph.

The masked nodes refer to nodes that are artificially masked during the training process, and whose original feature information has been removed and needs to be predicted by the model through contextual information. For example, in a robot perception system, if the initial feature graph comprises 100 nodes (e.g., LIDAR points, and visual detection frames), 20 nodes are randomly selected as the masked nodes.

The node feature vector of the masked node is replaced with the zero vector or the preset mask token.

The preset mask token refers to a special, learnable vector that replaces the original feature vector of the masked node. Unlike the zero vector, the preset mask token is able to adaptively adjust during the training process, which helps a model learn a mask prediction task better.

Step 320, using a graph attention network (GAT) as an encoder to encode nodes that are not masked.

The nodes that are not masked refer to nodes not selected during a random masking process. The nodes that are not masked retain original feature information and serve as a source of contextual information for the encoder learning. The nodes that are not masked provide important neighborhood information and global structure information for predicting features of the masked nodes.

In some embodiments, the processor may perform feature extraction and representation learning of the nodes that are not masked through the graph attention network to generate compact node representations by aggregating features of neighboring nodes using graph structure information to complete the encoding.

The node representations refer to compact vectors generated in a latent space after the nodes that are not masked have been processed by the encoder (i.e., the graph attention network) during a graph structure learning phase.

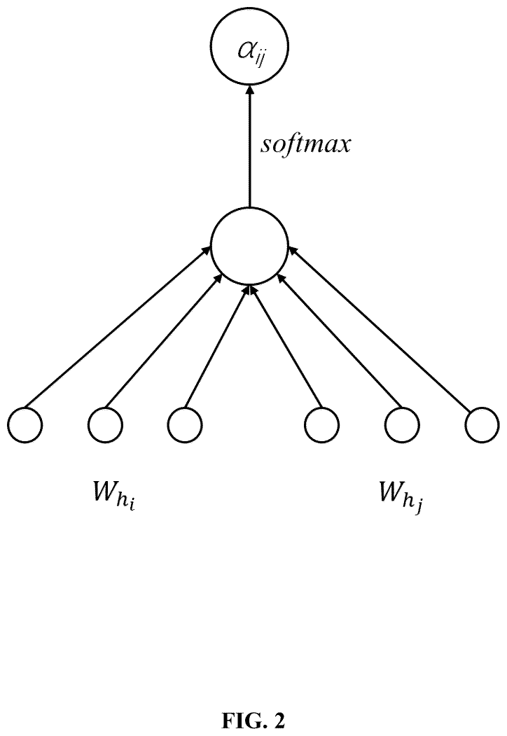

FIG. 2 is a schematic diagram of the graph attention network model architecture according to some embodiments of the present disclosure.

In some embodiments, the graph attention network calculates attention coefficients between nodes to perform weighted aggregation of information from a plurality of neighbor nodes, including: for each node, obtaining node feature vectors of a plurality of neighbor nodes of the each node at a current layer; for each neighbor node of the plurality of neighbor nodes, performing weighted aggregation on a node feature vector of the each neighbor node at the current layer based on a weight matrix of the current layer and an attention coefficient between the each node and a certain neighbor node, to obtain information of the plurality of neighbor nodes after weighted aggregation; and determining a node feature vector of the each node at a next layer through an activation function based on the information of the plurality of neighbor nodes.

The attention coefficient αij denotes a degree of attention of a node i to a node j.

In some embodiments, the processor computes respective corresponding feature vectors of the node i and the node j by concatenating them together through a single-layer feed-forward neural network, and subsequently determines the attention coefficient after processing them through the activation function. For example, in the robot perception system, if the node i represents an end of the robotic arm and the node j represents a target object, the attention coefficient αij reflects the degree of attention of the end of the robotic arm to the target object, and a large value indicates a strong correlation between them.

The neighbor node refers to a set of nodes N(i) that are directly connected to the current node.

In some embodiments, the processor obtains the neighbor node based on spatial distances (e.g., points in a LIDAR point cloud with distances less than a threshold), based on semantic associations (e.g., interacting objects in a visual scene), or based on temporal sequences (e.g., the state of successive time steps). For example, in a robot grasping task, the neighbor nodes of the node of a robotic arm end may include a target object node, an obstacle node, and a support plane node.

The activation function refers to a nonlinear function that is used to introduce nonlinear transformation capabilities to enhance the expressive power of a model. For example, the activation function includes Rectified Linear Unit (ReLU), Leaky Rectified Linear Unit (LeakyReLU), and Exponential Linear Unit (ELU). As shown in FIG. 2, in the GAT network, each node not only pays attention to its own features, but also the features of the other nodes it is connected to. For example, each node in FIG. 2 has the attention coefficient that is used to determine the importance of its relationships with other nodes. First, the attention coefficient is computed, which is usually a scalar value indicating the degree of attention of the node i to the node j. This means that attention can be allocated to all relevant nodes, not just a single node. The attention coefficient is multiplied by the corresponding node feature vector to obtain a weighted average that reflects the weighted aggregation of the node feature vector of the node i to those of its neighboring nodes. Finally, the weighted aggregation is combined with the node feature vector of the node j itself to generate new node representations.

That is, the graph attention network performs the weighted aggregation of neighbor information by computing attention weights between the nodes, exemplarily represented as:

$${h}_{i}^{( l + 1 )} = σ ( {\sum }_{j ∈ N ( i ) ⋃ \{ i \}} {α}_{ij} {w}^{( l )} {h}_{j}^{( l )} ) , \qquad ( 1 )$$

where, in formula (1)

$${h}_{i}^{( l )}$$

denotes the node feature vector of the node i at layer l, σ denotes the activation function, w^{(l)} denotes the weight matrix, αᵢⱼ denotes the attention coefficient between the node i and the node j, and N(i) denotes the set of the neighbor nodes of the node i.

Through the graph attention network, importance weights between the nodes can be adaptively learned, enabling selective attention to key information, which improves a quality of feature representation and an expressive power of the model. At the same time, the attention mechanism has a good interpretability, which can intuitively demonstrate the strength of the association between the nodes, and provides an important basis for the subsequent reconstruction of the graph structure.

Step 330, receiving, by the decoder, node representations generated by the encoder and mask information, and predicting node features of the masked nodes.

In some embodiments, the decoder employs a multi-layer perceptron.

In some embodiments, the decoder may further employs three fully connected layers to decode encoded information.

The encoded information refers to all of input information received by the decoder when performing decoding. For example, the encoded information includes the node representations, the mask information. The processor may collectively refer to the information input to the decoder as the encoded information.

In some embodiments, the decoder receives the node representations and the mask information output by the encoder. For each masked node indicated by the mask information, the decoder extracts its corresponding node representations and inputs the node representations into the decoder. The decoder performs a nonlinear transformation of the node representations and outputs a prediction vector as a feature of the masked node. A dimension of the prediction vector is the same as a dimension of the original feature of the masked node.

Step 340, determining a difference between an output of the decoder and node features of actual masked nodes based on a mean squared error loss function, and introducing an actual physical constraint into the mean squared error loss function (i.e., a final total loss function).

The actual physical constraint refers to a constraint imposed on model predictions based on the laws and constraints of the real physical world to ensure that the predictions are consistent with the laws of physics and the operating laws of the actual system.

In some embodiments, the actual physical constraint includes at least one of a dynamics constraint, a geometrical constraint, a contact constraint, and an energy conservation constraint. The dynamics constraint is determined for each time step by utilizing a dynamics model of the robot. The geometrical constraint is determined by utilizing the dynamics model of the robot. The geometrical constraint includes at least one of an invariant link length and a joint angle range constraint. The contact constraint is a constraint on a torque and a force at a contact point, and the contact constraint includes that a friction force is not capable of exceeding a maximum static friction constraint. The energy conservation constraint ensures that a total energy of a system is conserved, that is, a conversion between potential energy, kinetic energy, and work performed obeys a law of conservation of energy.

In some embodiments, the dynamics constraint, the geometrical constraint, the contact constraint, and the energy conservation constraint are not mutually exclusive and can be introduced simultaneously, depending on the actual operating state of the robot. For example, for instance, when the robotic arm of the robot is moving, its linkage length needs to remain constant, i.e., there is the geometrical constraint. Furthermore, a movement of the robotic arm needs to follow Newton's second law, i.e., there is the dynamics constraint. Finally, a total energy change is required to be conserved during the movement of the robotic arm, i.e., there is the energy conservation constraint.

In some embodiments, each of the actual physical constraints is not applied indiscriminately to all nodes, but is precisely applied to the subset of physical nodes directly related to it (e.g., the geometrical constraint applies to joint nodes, the contact constraint applies to sensor nodes). Then, with the help of the message passing mechanism of the graph neural network, the impact of the constraints imposed on physical nodes is able to be automatically propagated along the edges of the graph to other relevant nodes, such as visual pixel nodes or auditory nodes. For example, a predicted joint angle violating the geometrical constraint, through the graph structure, causes its corresponding visual prediction to also be deemed unreliable.

The dynamics constraint refers to a constraint imposed on a state of motion of the robotic system based on the laws of Newtonian mechanics.

The geometrical constraint refers to a constraint imposed on geometric parameters, such as a range of a joint angle and a link length, based on the kinematic model of the robot.

The contact constraint refers to a constraint imposed on a force and a torque at a contact point based on principles of contact mechanics.

The energy conservation constraint refers to a constraint imposed on a total energy of a system based on the law of conservation of energy.

By introducing the actual physical constraint, a physical plausibility and a realism of predictions of the model can be improved, avoiding results that violate physical laws.

In some embodiments, the processor combines an original loss function with one or more additional loss terms that are used to penalize predictions that do not conform to the laws of physics. The final total loss function can be exemplarily represented as follows.

$$L = {L}_{b a s e} + λ {L}_{p hys} , \qquad ( 2 )$$

where, in formula (2), λ denotes a hyperparameter to adjust an importance of physical constraints, L_{base} denotes a base loss term based on a mean square error, L_{phys} denotes an actual physical constraint loss term, which is a weighted sum of the loss terms corresponding to a plurality of actual physical constraints imposed, and L denotes the final total loss function.

A specific form of the actual physical constraint in terms of the dynamics constraint and the geometrical constraint can be exemplified as:

For an ordinary second-order system, the loss function under the dynamics constraint can be exemplarily expressed as:

$${L}_{p h y s} = {\vert m \ddot{x} - F ( t ) + c \dot{x} + kx \vert}^{2} , \qquad ( 3 )$$

where, in formula (3), m denotes a mass, c, k denote physical coefficients, F(t) denotes an external force, and x and \dot{x} are a predicted position and a velocity, respectively.

For the robotic arm, if the length of the link is known to be fixed, a constraint term can be added to penalize those predicted combinations of joint angles, exemplarily represented as follows:

$${L}_{p h y s} = {\vert ‖ {l}_{1} cos ( {θ}_{1} ) + {l}_{2} cos ( {θ}_{1} + {θ}_{2} ) ‖ - {d}_{12} \vert}^{2} , \qquad ( 4 )$$

where, in formula (4), lᵢ denotes the length of the i^{th} linkage, θᵢ denotes an angle of the joint i, and d₁₂ denotes a theoretical fixed distance between the two ends.

Other loss functions can be built by referring to the above manner, and will not be repeated here.

In step 350, performing gradient descent on parameters of the autoencoder by utilizing the mean squared error loss function to minimize a loss until the autoencoder converges or reaches a predetermined training epoch to obtain a trained autoencoder.

In some embodiments, an Adam optimization algorithm may be used to compute the gradient of the loss function over the model parameters by back propagation, and then updating the parameters in the opposite direction of the gradient, and repeating the above step 310-step 350 until the autoencoder converges or reaches the predetermined training epoch.

Step 360, utilizing the trained autoencoder to learn node mappings of the plurality of types of perception data on the graph neural network, and establishing connections between nodes according to intrinsic correlations among the plurality of types of perception data to form an undirected graph.

The intrinsic correlation refers to an essential correlation and a dependency that exist between different types of perception data. For example, the intrinsic correlation includes a causal relationship (e.g., a movement of the robotic arm results in a change in a position of an object), a spatial relationship (e.g., a relative position and distance between objects).

In some embodiments, the processor may encode the different types of the perception data using the trained autoencoder to obtain a vector representation of each node. A similarity or a correlation metric (e.g., a cosine similarity and an Euclidean distance) between the node representations is then computed. Connections between the nodes are established based on criteria like a similarity threshold. Finally, by constructing an adjacency matrix, the undirected graph structure is formed.

Through the graph structure reconstruction manner based on the autoencoder, the compact representation of the initial feature graph can be effectively learned, the intrinsic correlation between the perception data can be automatically discovered, and the graph structure conforming to physical laws can be constructed. It not only improves a quality and an efficiency of the feature representation, but also enhances a generalization ability of the model.

FIG. 4 is an exemplary flowchart of a process for performing numerical encoding on node feature vectors according to some embodiments of the present disclosure.

In some embodiments, process 400 is performed by the processor as shown in FIG. 4. Process 400 includes step 410-step 430:

Step 410, initializing each node of the perception data, and converting the each node into an initial node feature vector using a multi-layer perceptron.

In some embodiments, first, the processor performs data preprocessing (e.g., a data cleansing, a normalization, and a feature extraction) on nodes of the perception data. Then, the preprocessed data is input into the multi-layer perceptron to compute the initial node feature vector. During the initialization process, weight parameters of the multi-layer perceptron are set using random initialization or pre-training to ensure that each node obtains a semantically meaningful feature representation.

The initial node feature vectors are vector representations obtained by encoding raw perception data through the multi-layer perceptron. For example, for visual perception data, the initial node feature vector may include color of the image, texture of the image, and shape of the image; for force perception data, the initial node feature vector may include a magnitude of force, a direction of force, and a rate of change of force.

In some embodiments, the processor may input the original initial perception data into the input layer of the multi-layer perceptron, perform a nonlinear transformation through the hidden layer, and obtain a fixed-dimension feature vector in the output layer. The feature vectors are then normalized to ensure that all the node feature vectors are within the same scale, which in turn yields the initial node feature vectors.

Step 420, utilizing a message passing mechanism of the graph neural network to allow the each node to exchange information with neighbor nodes of the each node, and updating the node feature vector of the each node in each layer.

The exchanging information refers to a process of aggregation and updating. For example, in each layer of the graph neural network, each node receives the node feature vectors of its neighbor nodes, aggregates a plurality of node feature vectors using an aggregation function to obtain a result, fuses the result with the node feature vector of the node in the current layer, and updates the node feature vector of the node for the next layer through a nonlinear transformation.

In some embodiments, updating the node feature vectors of each node is intended to capture interrelationships between the perception data by making the node include information of the neighbor nodes.

More descriptions regarding how to update the node feature vector for each node may be found elsewhere in the present disclosure (e.g., FIG. 3 and related descriptions thereof).

Step 430, after a plurality of iterations of the graph neural network, obtaining an embedding vector by the each node. The embedding vector includes a node feature of the each node itself and node features of neighbor nodes fused by the each node, and the embedding vector is used as a learned representation of the high-dimensional feature vectors.

The plurality of iterations refers to an operation of iteratively updating the node feature vector of each node at each layer of the graph neural network. An input of the i+1^{th} iteration is the node feature vector of each node, output from the i(i≥1)^{th} iteration; in the i^{th} iteration, each node aggregates the node feature vectors of its neighbor nodes in the i−1^{th} iteration and updates its own node feature vector based on it to generate the node feature vector of the i^{th} iteration. When i=1, an input to the 2^{th} round of iteration is the initial node feature vector of each node.

Each round of iteration corresponds to one layer of processing of the graph neural network, please refer to step 420 for the way of each round of iteration, which will not be repeated here. After K rounds of iterations (i.e., processing the K layers), the output embedding vector of each node can aggregate the information of all neighbor nodes in the K layers, thus gaining the ability to perceive a larger range of graph structures.

In some embodiments, at each layer of the graph neural network, the node collects information from the neighbor nodes via the aggregation function. The processor updates the node representations by fusing (e.g., concatenating or summing operations) the aggregated neighbor information with the own features of the node, followed by a nonlinear activation function and a linear transformation layer. After a plurality of layers of processing, a final embedding vector is obtained.

Using the graph neural network to numerically encode the node feature vectors, complex correlations and interdependencies between the plurality of types of perception data can be effectively captured, resulting in a high-dimensional feature vector representation with rich semantic information.

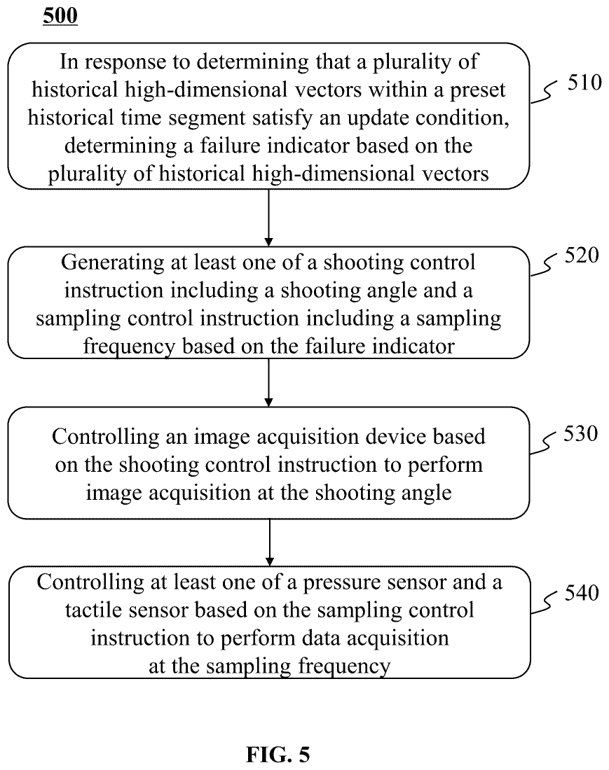

FIG. 5 is an exemplary flowchart of a process for performing image acquisition and data acquisition according to some embodiments of the present disclosure.

In some embodiments, process 500 is executed by the processor as shown in FIG. 5. Process 500 includes step 510-step 540.

There are known to be two situations, i.e., a plurality of historical high-dimensional vectors within a preset historical time segment that satisfy an update condition and the plurality of historical high-dimensional vectors within the preset historical time segment that do not satisfy the update condition.

Step 510, in response to determining that the plurality of historical high-dimensional vectors within the preset historical time segment satisfy the update condition, determining a failure indicator based on the plurality of historical high-dimensional vectors.

The preset historical time segment refers to time before a current time, which can be set based on experience. For example, the preset historical time segment includes 10 seconds, 30 seconds, or 1 minute before the current time.

The plurality of historical high-dimensional vectors refer to high-dimensional feature vectors generated by the graph neural network after encoding the perception data from a plurality of moments in the past during the preset historical time segment.

The update condition refers to a trigger condition that determines whether a current data collection manner is valid. For example, the update condition includes the plurality of historical high-dimensional vectors having a variance greater than a preset variance threshold.

The preset variance threshold can be set empirically.

In some embodiments, the processor takes a mean value of all diagonal elements in a covariance matrix of the plurality of historical high-dimensional vectors as a variance of the plurality of historical high-dimensional vectors.

In some embodiments, in the covariance matrix, the (i, j)^{th} element denotes a mean value of a product of a bias in the i^{th} dimension and a bias in the j^{th} dimension over N samples. Diagonal elements of the covariance matrix, i.e., the (i, i)^{th} element, denote a variance in the i^{th} dimension.

In response to determining that the plurality of historical high-dimensional vectors within the preset historical time segment satisfy the update condition, it indicates that the current data collection parameters may no longer be adapted to the actual needs and need to be adjusted and optimized. In response to determining that the plurality of historical high-dimensional vectors within the preset historical time segment do not satisfy the update condition, an image acquisition continues at the current shooting angle, and data acquisition continues at the current sampling frequency.

In some embodiments, the update condition may be set empirically.

In some embodiments, the processor may determine the update condition based on an offset feature.

The offset feature refers to a gap between a current state of the robot and a mission goal. For example, the offset feature includes a position offset and a pressure offset. The position offset is obtained by calculating the Euclidean distance between a current end position and a target position, and the pressure offset is obtained by calculating a difference between a current applied pressure and a preset pressure.

The current state may be characterized by the high-dimensional feature vector, and the mission goal may be characterized by a preset task parameter.

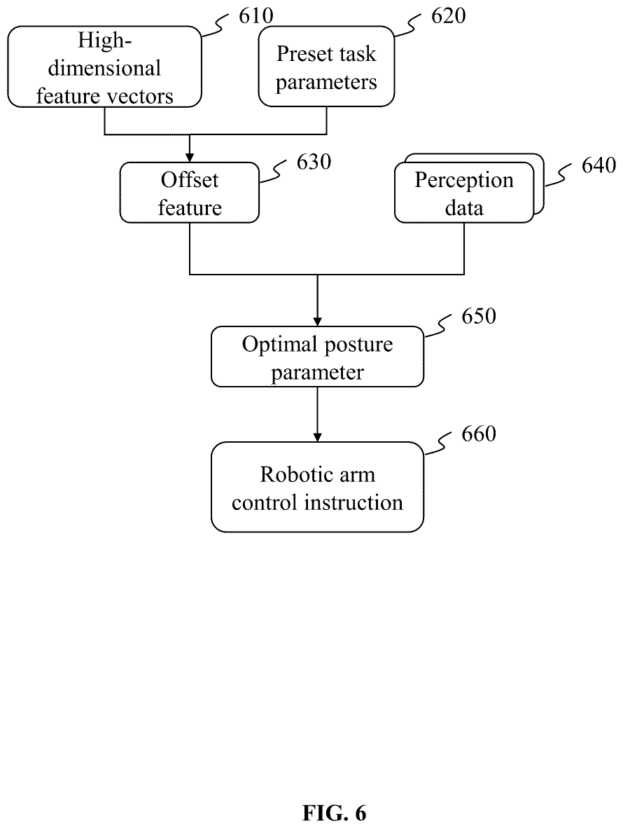

More descriptions regarding the offset feature may be found elsewhere in the present disclosure (e.g., FIG. 6 and related descriptions thereof).

In some embodiments, the processor may determine the preset variance threshold based on a preset variance threshold in the update condition that is positively correlated with the mean value of the position offsets and the pressure offsets in the offset feature.

Adjusting the preset variance threshold based on the offset feature allows the robot to operate in a “coarse and fast” mode for efficiency in early stages of a task and automatically switch to a “fine and slow” mode for successful precise operations near the target, ensuring the quality and efficiency of image acquisition or data acquisition.

The failure indicator refers to an indicator used to identify a specific data quality issue that caused the update condition to be triggered. For example, the failure indicator includes at least one of blurred visual information or blurred tactile information.

The blurred visual information refers to a poor quality of visual data acquired by the image acquisition device (e.g., a camera), resulting in inadequate information acquisition. Causes of the blurred visual information include: physical occlusion of the camera lens; a suboptimal camera shooting angle leading to unclear imaging or loss of features of the target object in the image; or the target position being in a blind spot of the camera due to a current posture of the robotic arm, preventing acquisition of key visual information of the target.

The blurred tactile information refers to a poor quality of tactile data acquired by a pressure sensor and/or a tactile sensor, resulting in an inability to accurately perceive the contact state. Causes of blurred tactile information include: insufficient sampling frequency of the sensor, preventing it from capturing subtle dynamic changes or instantaneous contact forces between an end-effector of the robotic arm and an operating environment at a high enough frequency, thus causing loss or distortion of tactile information.

In some embodiments, the processor may sort the diagonal elements of the covariance matrix of the plurality of historical high-dimensional vectors in descending order, and use indicators corresponding to the dimensions of the first N diagonal elements of the sorted order, as the failure indicator.

The indicators corresponding to dimensions refer to a preset range of representations in the high-dimensional feature vectors, e.g., dimensions 1-64 mainly encode visual features and dimensions 65-96 mainly encode tactile features, and the N values are set empirically.

Step 520, generating at least one of a shooting control instruction including a shooting angle or a sampling control instruction including a sampling frequency based on the failure indicator.

The shooting control instruction refers to an instruction for adjusting an operating parameter of the image acquisition device.

The shooting angle refers to a spatial orientation parameter of the image acquisition device with respect to a target object. The shooting angle includes a horizontal angle, a vertical angle, etc.

In some embodiments, when the failure indicator is the blurred visual information, the processor determines a corresponding shooting angle based on object position information in the image data and the current shooting angle, and then generates the shooting control instruction. For example, the processor obtains position information of the object in a frame through an object detection algorithm; determines a target angle based on the object position information and the position information of the robot in the high-dimensional feature vectors; and determines the angle to be adjusted based on the target angle and the current shooting angle. For example, adjust the current angle rightward by X degrees and downward by Y degrees. In turn, convert the angle to be adjusted into an instruction format to generate the shooting control instruction.

The target angle refers to an angle of the object relative to the camera. The processor may obtain the target angle by translating the object position information into a robot base coordinate system.

The sampling control instruction refers to an instruction used to adjust a sampling frequency of the sensors.

The sampling frequency refers to a count of times the sensor collects data per unit of time. For example, the sampling frequency includes 10 Hz, 50 Hz, and 100 Hz.

In some embodiments, when the failure indicator is the blurred tactile information, the processor determines the sampling frequency based on the mean value of the diagonal elements of the dimensions of the tactile information, by means of a preset table. The sampling frequency is then converted to a sensor control instruction format to generate the sampling control instruction.

The preset table may include a correspondence between the mean value of the diagonal elements of the dimensions of the tactile information and the sampling frequency. The preset table may be determined based on the mean value of the diagonal elements of the dimensions of the tactile information in historical data, in relation to the actual sampling frequency.

In some embodiments, the diagonal elements of the dimensions of the tactile information are the variances corresponding to the tactile information. The larger the mean value of the variances is, the more ambiguous the tactile information is, and an increase in the sampling frequency is required.

Step 530, controlling the image acquisition device based on the shooting control instruction to perform image acquisition at the shooting angle.

The image acquisition device refers to a device for acquiring visual information. The image acquisition device includes an optical imaging device, such as a camera probe, a camera, and a video camera. For example, the image acquisition device includes a high-definition industrial camera mounted at the end of an arm of a robot, a surveillance camera that is fixed in a work environment.

In some embodiments, the process of the processor performing image acquisition based on the shooting control instruction includes: 1) receiving the shooting control instruction; 2) parsing the shooting angle in the instruction; 3) controlling the head or mechanism of the image acquisition device to adjust to the specified shooting angle; and 4) continuously performing image acquisition at the adjusted angle.

Step 540, controlling at least one of the pressure sensor or the tactile sensor based on the sampling control instruction to perform data acquisition at the sampling frequency.

More descriptions regarding the pressure sensor, the tactile sensor may be found elsewhere in the present disclosure (e.g., FIG. 1 and related descriptions thereof).

In some embodiments, the processor performs the data acquisition including: 1) receiving the sampling control instruction; 2) parsing the sampling frequency in the sampling control instruction; 3) configuring the sampling frequency of the pressure sensor and/or the tactile sensor; and 4) performing data acquisition at the set sampling frequency.

By determining the failure indicator and generating the shooting control instruction and the sampling control instruction, the image acquisition device, the pressure sensor, and the tactile sensor are controlled in a targeted manner, thereby proactively improving the quality and effectiveness of the perception data.

FIG. 6 is a schematic diagram of generating a robotic arm control instruction according to some embodiments of the present disclosure.

In some embodiments, as shown in FIG. 6, the processor determines an offset feature 630 based on the high-dimensional feature vectors 610 and a preset task parameter 620, determines an optimal posture parameter 650 through a vector database according to the offset feature 630 and a plurality of types of perception data 640, generates a robotic arm control instruction 660 including an optimal posture and an optimal position according to the optimal posture parameter 650, and controls a robotic arm based on the robotic arm control instruction 660 to apply a pressure at the optimal position with the optimal posture.

More descriptions regarding the high-dimensional feature vectors may be found elsewhere in the present disclosure (e.g., FIG. 1, FIG. 4, and related descriptions thereof). More descriptions regarding the perception data may be found elsewhere in the present disclosure (e.g., FIG. 1 and related descriptions thereof). More descriptions regarding the offset feature may be found elsewhere in the present disclosure (e.g., FIG. 5 and related descriptions thereof)

The preset task parameter refers to a parameter corresponding to a task that the robot needs to accomplish, including the target position and the preset pressure.

In some embodiments, the processor compares the high-dimensional feature vectors with the preset task parameters and calculates the difference between the two in terms of the position and the pressure, which in turn serves as the offset feature.

The optimal posture parameter refers to an optimal combination of attitude and position parameters that the robot should achieve in order to reduce the offset feature.

In some embodiments, after detecting an error (e.g., due to obstacles, reading errors, and calculation errors) between an actual posture of the robot and a target posture of the robot, the processor re-matches the optimal posture that may be adjusted from the current posture by querying the vector database based on perception information of the robot and deviation characteristics.

In some embodiments, the processor may determine the optimal posture parameter in various ways. For example, the processor may concatenate the offset feature and the perception data to construct a posture feature vector, and then, based on the posture feature vector, retrieve from a vector database to obtain the optimal posture parameter.

The vector database refers to a database used to determine the optimal posture parameter. The vector database includes a plurality of reference vectors, and a reference posture parameter corresponding to each reference vector.

In some embodiments, the processor may construct the reference vectors based on historical data, and then calculate the similarity between each of the reference vectors and the posture feature vector, and determine the optimal posture parameter corresponding to the posture feature vector. For example, the reference vector whose similarity with the posture feature vector satisfies a preset condition is taken as the target vector, and the reference posture parameter corresponding to the target vector is taken as the optimal posture parameter corresponding to the posture feature vector.

In some embodiments, the processor may obtain the historical posture parameter with the smallest historical offset feature computed after regulating as the reference posture parameter, among a plurality of historical regulatings, corresponding to the reference vector.

The preset condition may be determined as appropriate. For example, the preset condition may be that the similarity is greater than a predetermined similarity threshold. The similarity between the reference vector and the posture feature vector may be negatively correlated to a vector distance between the reference vector and the posture feature vector, which may be determined based on, e.g., a cosine distance. For example, the similarity may be the inverse of the vector distance.

The optimal posture is a posture that, under a current task condition, enables the offset feature of the robotic arm resulting from an execution of the operation to satisfy a deviation criterion.

The optimal position is a position that, under the current mission conditions, enables the offset feature generated by the robotic arm after performing an operation to satisfy the deviation criteria.

The deviation criteria may be set by a specialized technician.

The robotic arm control instruction refers to a set of instructions used to control a movement and an operation of the robotic arm.

In some embodiments, the processor extracts the optimal position and the optimal posture based on the optimal posture parameter and converts them into an instruction format recognizable by the robotic arm control system, thereby forming a complete robotic arm regulation instruction.

In some embodiments, the processor receives and parses the robotic arm control instruction, controls the robotic arm to move to the optimal position and adjust to the optimal posture, initiates the force control mode, and applies pressure in accordance with the preset pressure in the robotic arm control instruction.

In some embodiments, when the robotic arm applies the pressure, the processor obtains actual pressure data based on a pressure sensor, and controls a joint motor of the robotic arm based on a motor control instruction including an incremental step size to increase an output torque by the incremental step size until the actual pressure data reaches a preset pressure in the preset task parameter.

The actual pressure data refers to a pressure value measured by the pressure sensor in real time when the end-effector of the robotic arm is in contact with the object. For example, in an assembly task, the actual pressure data may be the contact force applied by the end-effector to the part.

In some embodiments, the pressure sensor is mounted on the end-effector of the robotic arm; when the robotic arm comes into contact with an object, the pressure sensor detects the contact force and converts it to an electrical signal; the electrical signal is sampled and quantized via a data acquisition system; and the quantized digital signal is transmitted to the processor to get the actual pressure data.

The incremental step size refers to a value of the torque increment that is adjusted each time during the gradual increase of the output torque. For example, the incremental step size includes 0.1 Nm and 0.5 Nm. The incremental step size may be set based on experience.

The motor control instruction refers to a set of instructions used to control the operation of the joint motor of the robotic arm.

The joint motor refers to an actuator that drives the movement of each joint of the robotic arm. For example, a six-degree-of-freedom robotic arm typically contains six joint motors corresponding to each of the six rotational joints.

The output torque refers to a rotational torque generated by the joint motor, which is used to drive the joints of the robotic arm in motion and overcome external loads.

In some embodiments, the processor determines the output torque in various ways based on the received motor control instruction. The motor control instruction includes the incremental step size for gradually adjusting the torque.

For example, the processor may take the preset pressure in the preset task parameter, compare the preset pressure to real-time pressure data, and calculate the pressure difference between the preset pressure and the real-time pressure data. The processor then calculates an adjustment amount of the torque based on the pressure difference, combined with a preset proportionality, integral, and other parameters. The processor combines the adjustment amount of the torque with a current output torque to determine the output torque and transmits to the motor driver of the robotic arm.

Through real-time measured pressure data and continuous feedback to adjust the motor output, it realizes closed-loop precision control of the pressure applied by the end of the robotic arm and ensures the accuracy of the final applied force.

By accurately calculating the gap between the current state and the target task and generating the robotic arm control instruction, the robotic arm applies pressure at the optimal position with the optimal posture, which realizes intelligent and adaptive robotic arm operation, and significantly improves the operation precision and efficiency of the robotic system.

The above describes in detail a preferred specific embodiment of the present disclosure. One of ordinary skill in the art can make numerous modifications and variations in accordance with the ideas of the present disclosure without creative labor. Therefore, any technical solution that can be obtained by logical analysis, reasoning, or limited experimentation by a person of ordinary skill in the art on the basis of the prior art according to the conception of the present disclosure should be within the scope of protection as determined by the claims.

1. A method for token-based representation and learning of robotic perception data based on a graph neural network, comprising:
S1, data obtaining: obtaining a plurality of types of perception data of a robot;
S2, performing token-based representation according to types of the plurality of types of perception data;
S3, token-based representation learning:
S31, constructing an initial feature graph based on the plurality of types of perception data after the token-based representation;
S32, learning a compact representation of a feature graph based on an autoencoder and reconstructing a graph structure, wherein the graph structure represents a relationship of edges between different nodes, the autoencoder includes an encoder and a decoder, the encoder employs a graph attention network, the encoder is configured to map node features to a latent space, and the decoder reconstructs an initial graph structure from the latent space;
the learning a compact representation of a feature graph based on an autoencoder and reconstructing a graph structure including:
random masking: selecting a portion of nodes for masking to obtain masked nodes, wherein a masking manner includes a random selection strategy, and for a feature vector corresponding to a masked node, the feature vector is replaced with a zero vector or a preset mask token;
encoding: using the graph attention network as the encoder to encode nodes that are not masked;
decoding: receiving, by the decoder, node representations generated by the encoder and mask information, and predicting features of the masked nodes;
loss function definition: defining a mean squared error loss function to measure a difference between an output of the decoder and features of actual masked nodes, and introducing an actual physical constraint into the mean squared error loss function;
backpropagation and iterative training: performing gradient descent on model parameters of the autoencoder by utilizing the mean squared error loss function to minimize a loss until the autoencoder converges or reaches a predetermined training epoch to obtain a trained autoencoder; and
utilizing the trained autoencoder to learn node mappings of the plurality of types of perception data on the graph neural network, and establishing connections between nodes according to intrinsic correlations among the plurality of types of perception data to form an undirected graph;
S33, after the autoencoder completes learning of the graph structure, fixing the graph structure; and
S34, converting the plurality of types of perception data into node feature vectors, constructing a feature graph based on the graph structure, and performing numerical encoding on each of the node feature vectors by utilizing the graph neural network to obtain a representation of high-dimensional feature vectors of the plurality of types of perception data;
the performing numerical encoding on each of the node feature vectors by utilizing the graph neural network to obtain a representation of high-dimensional feature vectors of the plurality of types of perception data including:
initializing each node corresponding to each piece of perception data, and converting initial numerical values into an initial node feature vector using a multi-layer perceptron;
utilizing a message passing mechanism of the graph neural network to allow the each node to exchange information with neighbor nodes of the each node, and updating a representation of the each node in each layer and aggregating information from the neighbor nodes into the representation of the each node to capture interrelationships between the plurality of types of perception data; and
a plurality of iterative optimizations: after a plurality of iterations of the graph neural network, obtaining a new embedding vector by the each node, wherein the new embedding vector includes a node feature of the each node itself and the information from the neighbor nodes fused by the each node, and the new embedding vector is used as a learned representation of the high-dimensional feature vectors.

2. The method according to claim 1, wherein the plurality of types of perception data includes degree-of-freedom state data, end-effector pose data, visual perception data, tactile perception data, and pressure sensor data.

3. The method according to claim 1, wherein in step S2, for perception data of a discrete data type, perception data of different kinds is treated as different tokens and the token-based representation is performed, wherein the different tokens correspond to different nodes in the graph neural network.

4. The method according to claim 1, wherein in step S2, for perception data of continuous numerical input, the graph attention network is used as an embedding network to learn a high-dimensional representation of numerical values and relationships and structures between the numerical values are captured.

5. The method according to claim 1, wherein in step S2, for perception data of temporal data, the temporal data is divided into a plurality of time segments according to a preset time length, and feature extraction or an encoding process is performed on each of the plurality of time segments to obtain the token-based representation; or, the temporal data is transformed to obtain time-domain features or frequency-domain features, and the time-domain features or the frequency-domain features are used as the token-based representation.

6-11. (canceled)

12. The method according to claim 1, further comprising:
in response to determining that a plurality of historical high-dimensional vectors within a preset historical time segment satisfy an update condition, determining a failure indicator based on the plurality of historical high-dimensional vectors;
generating at least one of a shooting control instruction including a shooting angle or a sampling control instruction including a sampling frequency based on the failure indicator;
controlling an image acquisition device based on the shooting control instruction to perform image acquisition at the shooting angle; and
controlling at least one of a pressure sensor or a tactile sensor based on the sampling control instruction to perform data acquisition at the sampling frequency.

13. The method according to claim 12, wherein the update condition is determined based on an offset feature.

14. The method according to claim 1, further comprising:
determining an offset feature based on the high-dimensional feature vectors and a preset task parameter;
determining an optimal posture parameter through a vector database according to the offset feature and the plurality of types of perception data;
generating a robotic arm control instruction including an optimal posture and an optimal position according to the optimal posture parameter; and
controlling a robotic arm based on the robotic arm control instruction to apply a pressure at the optimal position with the optimal posture.

15. The method according to claim 14, further comprising:
when the robotic arm applies the pressure, obtaining actual pressure data based on a pressure sensor; and
controlling a joint motor of the robotic arm based on a motor control instruction including an incremental step size to increase an output torque by the incremental step size until the actual pressure data reaches a preset pressure in the preset task parameter.

16. The method according to claim 1, wherein the graph attention network calculates attention coefficients between the each node and the neighbor nodes to perform weighted aggregation of the information from the neighbor nodes, representing as:
$${h}_{i}^{( l + 1 )} = σ ( {\sum }_{j ∈ N ( i ) ⋃ \{ i \}} {α}_{ij} {w}^{( l )} {h}_{j}^{( l )} ) , \qquad ( 1 )$$
wherein,
$${h}_{i}^{( l )}$$
denotes a representation or a node i at a layer l, σ denotes an activation function, w^{(l)} denotes a weight matrix, αᵢⱼ denotes an attention coefficient between the node i and a node j, and N(i) denotes a set of neighbor nodes of the node i.

17. The method according to claim 1, wherein the decoder employs a multi-layer perceptron, and the decoder further employs three fully connected layers to decode encoded information.

18. The method according to claim 1, wherein the actual physical constraint includes:
a dynamics constraint: wherein the dynamics constraint is determined for each time step by utilizing a dynamic model of the robot;
a geometrical constraint: wherein the geometrical constraint is determined by utilizing the dynamic model of the robot, and the geometrical constraint includes an invariant link length and a joint angle range constraint;
a contact constraint: wherein the contact constraint is a constraint on a torque and a force at a contact point, and the contact constraint includes that a friction force is not capable of exceeding a maximum static friction constraint; and
an energy conservation constraint: wherein the energy conservation constraint ensures that a total energy of a system is conserved, indicating that a conversion between potential energy, kinetic energy, and work performed obeys a law of conservation of energy.
